(19) United States
(12) Patent Application Publication
(10) Pub. No.: US 2026/0072398 A1
(43) Pub. Date: Mar. 12, 2026

(54) IMAGE FORMING APPARATUS

(71) Applicant: CANON KABUSHIKI KAISHA, Tokyo (JP)

(72) Inventor: TATSUHITO WATANABE, Tokyo (JP)

(21) Appl. No.: 19/280,603

(22) Filed: Jul. 25, 2025

(30) Foreign Application Priority Data
Sep. 11, 2024 (JP) 2024-157349

(51) Int. Cl. G03G 21/20; G03G 15/00

(52) U.S. Cl. CPC G03G 21/206; G03G 15/657; G03G 15/6573

(57) ABSTRACT

An image forming apparatus that forms an image on a sheet material, and includes a conveyance member located downstream of a fixing portion in a conveyance direction of the sheet material and configured to convey the sheet material to which a toner image has been fixed in a fixing nip portion, an exhaust duct provided with a filter and configured to take in air inside the image forming apparatus and exhaust the air to outside of the image forming apparatus, and a fan connected to an exhaust port of the exhaust duct, in which the exhaust duct includes a first exhaust path portion located between a transfer nip portion and the fixing nip portion and configured to exhaust air via the filter, and a second exhaust path portion located between the fixing nip portion and the conveyance member and configured to exhaust air without intervention of the filter.

### BACKGROUND

### Field of the Technology

The present disclosure relates to an image forming apparatus such as a copying machine, a printer, or a facsimile, which form an image on a sheet, or a multifunction peripheral having a plurality of such functions.

### Description of the Related Art

In general, in an electrophotographic image forming apparatus, a toner image is formed on a sheet material by using toner having a release agent in an image forming portion. The image forming apparatus fixes the toner image on the sheet material by heating and pressurizing the sheet material on which the toner image is formed in a fixing portion. In this case, in the fixing portion, the sheet material is heated, so that water vapor held inside the sheet material evaporates. In a case where such water vapor adheres to a conveyance path or the like in the apparatus, dew condensation may occur to cause a quality problem such as an image defect, and thus it is required to appropriately discharge the water vapor to the outside of the apparatus.

In the fixing portion, in a case where the release agent contained in the toner is heated, volatile organic compounds (VOCs) are released from the surface of the heated portion or the surface of the toner or the sheet material of which the temperature has become high. In the fixing portion, in a case where the release agent contained in the toner is heated, ultra fine particles (UFPs) are released from the surface of the heated portion or the surface of the toner or the sheet material of which the temperature has become high.

Here, a UFP has a particle size of 100 nm or less. In recent years, in consideration of the influence of UFPs on the human body, the regulation of the emission amount of fine particles from an image forming apparatus has been progressing, and in particular, the regulation of Blue Angel, which is an environmental regulation in Europe, and the like are well known. It is expected that such environmental regulations will be stricter in the future, and mounting of a mechanism for reducing UFPs in an image forming apparatus is also in progress.

In such a situation, Japanese Patent Application Laid-Open No. 2015-219432 discloses an image forming apparatus having a configuration in which a path through which water vapor is discharged to the outside of the apparatus and a path through which UFPs are collected are switched by a shutter, as a configuration of reducing UFPs while discharging water vapor. The image forming apparatus in Japanese Patent Application Laid-Open No. 2015-219432 is provided with a filter that collects UFPs in the path through which the UFPs are collected.

On the other hand, in recent years, an image forming apparatus having a small size and high productivity has been required. In order to realize high productivity, it is necessary to set a control temperature of a fixing device to be high. Accordingly, the generation of UFPs increases. Since the frequency of sheets passing through the fixing device per unit time also increases with high productivity, the amount of water vapor generated also tends to increase. Therefore, in recent image forming apparatuses, it has been necessary to efficiently realize discharge of water vapor and collection of UFPs in a small space.

However, in Japanese Patent Application Laid-Open No. 2015-219432, since the path through which water vapor is discharged to the outside of the apparatus and the path through which UFPs are collected are switched by the shutter, a lot of space is required for disposing the shutter and a mechanism that performs switching using the shutter. Therefore, Patent Document 1 has a problem that the size of the apparatus is increased.

### SUMMARY

It is desirable to provide an image forming apparatus capable of collecting UFPs and appropriately discharging water vapor to the outside of the apparatus without increasing the size of the apparatus.

An image forming apparatus according to the present invention is an image forming apparatus that forms an image on a sheet material, the image forming apparatus including an image forming portion configured to form a toner image by using toner, a transfer portion that includes a transfer nip portion configured to transfer the toner image formed by the image forming portion to the sheet material, a fixing portion that includes a fixing nip portion configured to heat the sheet material to which the toner image has been transferred in the transfer nip portion and fix the toner image to the sheet material, a conveyance member located downstream of the fixing portion in a conveyance direction of the sheet material and configured to convey the sheet material to which the toner image has been fixed in the fixing nip portion, an exhaust duct provided with a filter and configured to take in air inside the image forming apparatus and exhaust the air to outside of the image forming apparatus, and a fan connected to an exhaust port of the exhaust duct, in which the exhaust duct includes a first exhaust path portion located between the transfer nip portion and the fixing nip portion and configured to exhaust air via the filter, and a second exhaust path portion located between the fixing nip portion and the conveyance member and configured to exhaust air without intervention of the filter.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus according to a first embodiment of the present invention.

FIG. 2 is a schematic diagram of a part of the image forming apparatus according to the first embodiment of the present invention.

FIGS. 3A and 3B are cross-sectional views of a part of the image forming apparatus according to the first embodiment of the present invention.

FIG. 4 is a schematic diagram of a part of an image forming apparatus according to a second embodiment of the present invention.

FIGS. 5A and 5B are cross-sectional views of a part of the image forming apparatus according to the second embodiment of the present invention.

FIG. 6 is a schematic diagram of a part of an image forming apparatus to be compared with the image forming apparatus according to the second embodiment of the present invention.

FIGS. 7A and 7B are diagrams illustrating a relationship between an opening height and an intake air volume in an exhaust duct of the image forming apparatus according to the second embodiment of the present invention.

FIGS. 8A and 8B are schematic diagrams of a part of a modification example of the image forming apparatus according to the second embodiment of the present invention.

FIG. 9 is a schematic diagram of a part of an image forming apparatus according to a third embodiment of the present invention.

FIG. 10 is a schematic diagram of a part of an image forming apparatus according to a fourth embodiment of the present invention.

FIGS. 11A and 11B are cross-sectional views of a part of the image forming apparatus according to the fourth embodiment of the present invention.

FIG. 12 is a schematic diagram of a part of a modification example of the image forming apparatus according to the fourth embodiment of the present invention.

FIGS. 13A and 13B are cross-sectional views of a part of a modification example of the image forming apparatus according to the fourth embodiment of the present invention.

FIG. 14 is a schematic diagram of a part of an image forming apparatus according to a fifth embodiment of the present invention.

### DESCRIPTION OF THE EMBODIMENTS

Hereinafter, embodiments of the present invention will be described in detail with reference to the drawings. In each drawing, an X direction is a left-right direction, a Y direction is a front-rear direction, and a Z direction is an up-down direction.

### First Embodiment

### <Configuration of Image Forming Apparatus>

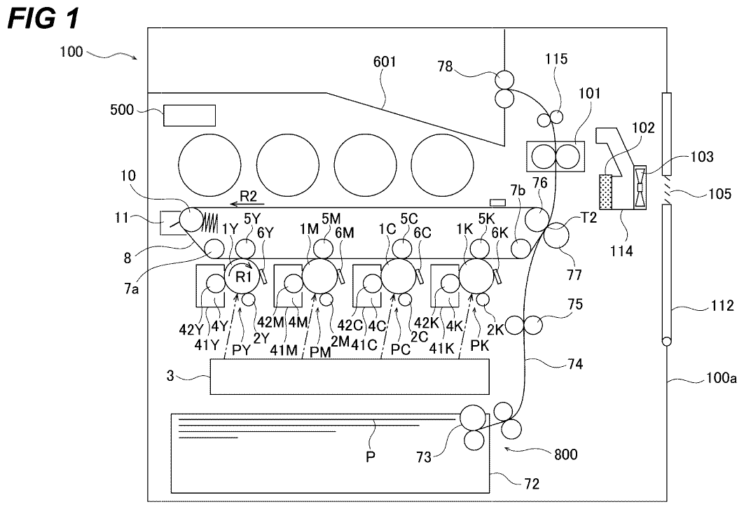

A configuration of an image forming apparatus 100 according to a first embodiment of the present invention will be described in detail with reference to FIGS. 1 to 3B.

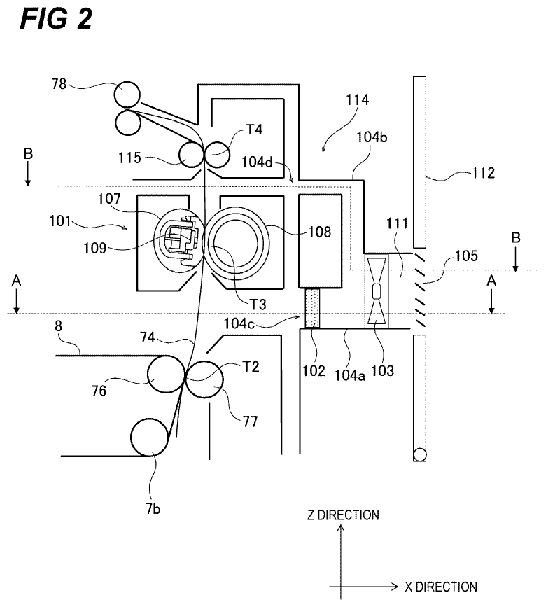

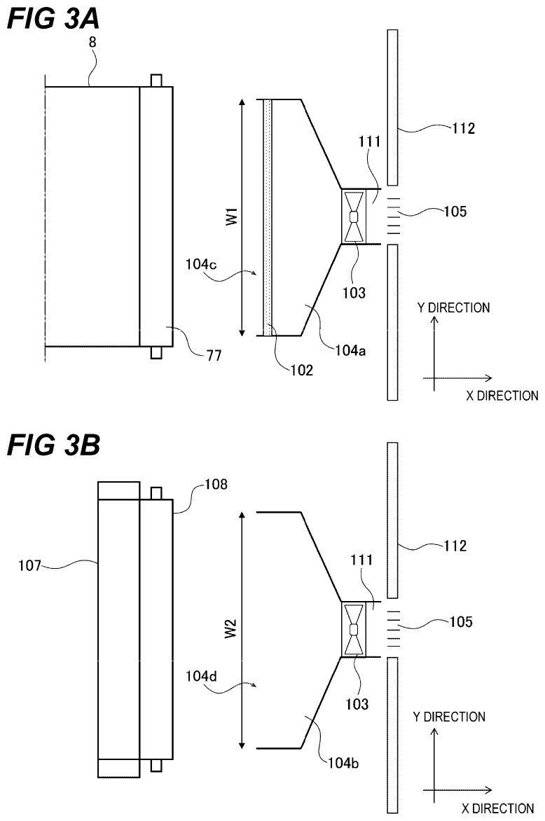

In FIGS. 3A and 3B, FIG. 3A is a cross-sectional view taken along line A-A in FIG. 2, and FIG. 3B is a cross-sectional view taken along line B-B in FIG. 2.

Here, an image forming apparatus 100 is exemplified by a laser type printer. The image forming apparatus 100 includes an image forming portion PY, an image forming portion PM, an image forming portion PC, an image forming portion PK, a laser scanner portion 3, an idler roller 7a, and an idler roller 7b. The image forming apparatus 100 includes an intermediate transfer belt 8, a tension roller 10, a transfer cleaner device 11, a registration roller 75, a secondary transfer inner roller 76, a secondary transfer outer roller 77, and a discharge roller 78. Furthermore, the image forming apparatus 100 includes a fixing portion 101, a filter 102, a fan 103, a louver 105, an exhaust port 111, a door 112, an exhaust duct 114, a discharge roller 115, a transfer portion 120, a controller 500, an in-body discharge portion 601, and a sheet feeding portion 800.

The image forming portion PY forms a yellow (Y) toner image. The image forming portion PY includes a photosensitive drum 1Y, a charging member 2Y, a developing device 4Y, a primary transfer roller 5Y, and a photosensitive drum cleaner 6Y.

The photosensitive drum 1Y is rotated in an R1 direction by a driving portion (not illustrated).

The charging member 2Y uniformly charges the surface of the photosensitive drum 1Y to a predetermined polarity and potential.

The developing device 4Y develops an electrostatic latent image formed on the photosensitive drum 1Y by the laser scanner portion 3 with toner to form a toner image on the photosensitive drum 1Y.

The primary transfer roller 5Y primarily transfers the toner image formed on the photosensitive drum 1Y by the developing device 4Y to the intermediate transfer belt 8.

The photosensitive drum cleaner 6Y removes transfer residual toner remaining on the photosensitive drum 1Y after the primary transfer by the primary transfer roller 5Y from the photosensitive drum 1Y.

The image forming portion PM forms a magenta (M) toner image. The image forming portion PM includes a photosensitive drum 1M, a charging member 2M, a developing device 4M, a primary transfer roller 5M, and a photosensitive drum cleaner 6M. Respective configurations of the photosensitive drum 1M, the charging member 2M, and the developing device 4M are the same as the configurations of the photosensitive drum 1Y, the charging member 2Y, and the developing device 4Y, and thus the description thereof will be omitted. Respective configurations of the primary transfer roller 5M and the photosensitive drum cleaner 6M are the same as the configurations of the primary transfer roller 5Y and the photosensitive drum cleaner 6Y, and thus the description thereof will be omitted.

The image forming portion PC forms a cyan (C) toner image. The image forming portion PC includes a photosensitive drum 1C, a charging member 2C, a developing device 4C, a primary transfer roller 5C, and a photosensitive drum cleaner 6C. Respective configurations of the photosensitive drum 1C, the charging member 2C, and the developing device 4C are the same as the configurations of the photosensitive drum 1Y, the charging member 2Y, and the developing device 4Y, and thus the description thereof will be omitted. Respective configurations of the primary transfer roller 5C and the photosensitive drum cleaner 6C are the same as the configurations of the primary transfer roller 5Y and the photosensitive drum cleaner 6Y, and thus the description thereof will be omitted.

The image forming portion PK forms a black (K) toner image. The image forming portion PK includes a photosensitive drum 1K, a charging member 2K, a developing device 4K, a primary transfer roller 5K, and a photosensitive drum cleaner 6K. Respective configurations of the photosensitive drum 1K, the charging member 2K, and the developing device 4K are the same as the configurations of the photosensitive drum 1Y, the charging member 2Y, and the developing device 4Y, and thus the description thereof will be omitted. Respective configurations of the primary transfer roller 5K and the photosensitive drum cleaner 6K are the same as the configurations of the primary transfer roller 5Y and the photosensitive drum cleaner 6Y, and thus the description thereof will be omitted.

The laser scanner portion 3 irradiates the surfaces of the photosensitive drums 1Y, 1M, 1C, and 1K uniformly charged by the charging members 2Y, 2M, 2C, and 2K with laser light based on an electric signal transmitted from an image reading apparatus or an external apparatus (not illustrated). The laser scanner portion 3 irradiates the surfaces of the photosensitive drums 1Y, 1M, 1C, and 1K with laser light to sequentially expose the surfaces of the photosensitive drums 1Y, 1M, 1C, and 1K to form electrostatic latent images on the surfaces of the photosensitive drums 1Y, 1M, 1C, and 1K.

The idler roller 7a stretches the intermediate transfer belt 8 together with the idler roller 7b, the tension roller 10, and the secondary transfer inner roller 76.

The idler roller 7b stretches the intermediate transfer belt 8 together with the idler roller 7a, the tension roller 10, and the secondary transfer inner roller 76.

The intermediate transfer belt 8 is rotated in an R2 direction by a driving portion (not illustrated) to convey the toner images primarily transferred from the photosensitive drums 1Y, 1M, 1C, and 1K by the primary transfer rollers 5Y, 5M, 5C, and 5K to a transfer nip portion T2.

The tension roller 10 stretches the intermediate transfer belt 8 together with the idler roller 7a, the idler roller 7b, and the secondary transfer inner roller 76.

The transfer cleaner device 11 removes the transfer residual toner remaining on the intermediate transfer belt 8 after passing through the transfer nip portion T2 from the intermediate transfer belt 8.

The registration roller 75 corrects skew feeding of a sheet material P fed from the sheet feeding portion 800 and conveys the sheet material P of which the skew feeding has been corrected to the transfer nip portion T2.

The secondary transfer inner roller 76 stretches the intermediate transfer belt 8 together with the idler roller 7a, the idler roller 7b, and the tension roller 10.

The secondary transfer outer roller 77 abuts on the secondary transfer inner roller 76 via the intermediate transfer belt 8 to form the transfer nip portion T2.

The secondary transfer inner roller 76 and the secondary transfer outer roller 77 nip the sheet material P conveyed by the registration roller 75 at the transfer nip portion T2 and apply a predetermined pressure to the sheet material P conveyed by the registration roller 75. The secondary transfer inner roller 76 and the secondary transfer outer roller 77 nip the sheet material P at the transfer nip portion T2 and apply a predetermined pressure to the sheet material P, thereby secondarily transferring the toner image primarily transferred to the intermediate transfer belt 8 to the sheet material P. The secondary transfer inner roller 76 and the secondary transfer outer roller 77 convey the sheet material P to which the toner image has been secondarily transferred to the fixing portion 101.

The discharge roller 78 discharges the sheet material P conveyed by the discharge roller 115 to the in-body discharge portion 601.

The fixing portion 101 heats and pressurizes the toner image secondarily transferred to the sheet material P conveyed by the secondary transfer inner roller 76 and the secondary transfer outer roller 77, thereby fixing the toner image onto the sheet material P. The fixing portion 101 conveys the sheet material P on which the toner image has been fixed to the discharge roller 115. The fixing portion 101 includes an endless belt 107, a pressure roller 108, and a heater 109.

As illustrated in FIG. 3A, the filter 102 extends in the width direction orthogonal to the conveyance direction and in the longitudinal direction of the secondary transfer outer roller 77. A width W1 of the filter 102 in the longitudinal direction is preferably equal to or larger than the width of the maximum size that allows the sheet material P to pass since UFPs are generated from the entire region of the image forming region of a fixing nip portion T3. The width W1 is exemplified here as 300 mm.

The filter 102 is provided on an intake port 104c side (that will be described later) of a first intake portion 104a, and collects (filters) UFPs from the air taken in from an intake port 104c. The filter 102 is desirably an electrostatic nonwoven fabric in the case of collecting UFPs caused by wax.

The electrostatic nonwoven fabric filter has a configuration in which fibers holding static electricity are formed on a nonwoven fabric, and can filter UFPs with high efficiency. The higher the density of the fibers, the higher the filtration performance, but the larger the pressure loss tends to be. This relationship also applies to a case where the thickness of the electrostatic nonwoven fabric is increased. If the charging intensity (the intensity of static electricity) of the fiber is increased, the filtration performance can be improved while the pressure loss is kept constant. The thickness of the electrostatic nonwoven fabric, the fiber density, and the charging intensity of the fiber are desirably appropriately set according to the filtration performance required for the filter 102.

The fan 103 is provided in the exhaust port 111 of the exhaust duct 114. The fan 103 forcibly discharges the air around the fixing nip portion T3 to the outside of the image forming apparatus 100 by generating a flow from the intake port 104c of the first intake portion 104a and an intake port 104d of a second intake portion 104b toward the exhaust port 111.

The endless belt 107 and the pressure roller 108 abut on each other to form the fixing nip portion T3. The endless belt 107 and the pressure roller 108 apply heat and pressure to the sheet material P by nipping and conveying the sheet material P at the fixing nip portion T3, thereby fixing the toner image secondarily transferred to the sheet material P onto the sheet material P.

The heater 109 heats the endless belt 107.

The louver 105 is provided on the door 112 and allows the inside of the exhaust duct 114 to communicate with the outside. The louver 105 enables air containing water vapor to be discharged from the exhaust duct 114 to the outside of the image forming apparatus 100. The louver 105 is set to discharge air containing water vapor in a desired direction such as a back surface direction or a side surface direction of the image forming apparatus 100.

The exhaust port 111 is provided between the fan 103 and the louver 105, and allows the first intake portion 104a and the second intake portion 104b to communicate with the outside of the image forming apparatus 100 via the louver 105.

The door 112 is provided on an apparatus side surface 100a of the image forming apparatus 100. The door 112 is opened and closed by being rotated in the front-rear direction. The door 112 is not limited to the configuration in which the door is opened and closed by being rotated in the front-rear direction, and may be of a drawer type.

The exhaust duct 114 is provided between the fixing portion 101 and the door 112. The exhaust duct 114 collects UFPs and discharges water vapor to the outside of the image forming apparatus 100. The exhaust duct 114 includes the first intake portion 104a and the second intake portion 104b.

The first intake portion 104a serving as a first exhaust path portion is provided on the opposite side to the exhaust port 111 with respect to the fan 103. The first intake portion 104a includes the intake port 104c at the end on the opposite side to the exhaust port 111 side. The intake port 104c is located between the fixing nip portion T3 and the transfer nip portion T2 in the up-down direction and takes in air. The first intake portion 104a is provided to collect, by the filter 102, a UFP which is a substance generated inside the image forming apparatus 100 mainly by heating toner containing a release agent. The first intake portion 104a exhausts air via the filter 102.

The second intake portion 104b serving as a second exhaust path portion is provided on the opposite side to the exhaust port 111 with respect to the fan 103. The second intake portion 104b includes the intake port 104d at the end on the opposite side to the exhaust port 111 side. The intake port 104d is located between the fixing nip portion T3 and a discharge nip portion T4 of the discharge roller 115 in the up-down direction and takes in air. The second intake portion 104b is provided to discharge water vapor generated inside the image forming apparatus 100 to the outside of the image forming apparatus 100. A width W2 of the second intake portion 104b in the longitudinal direction is preferably the width of the maximum size that allows the sheet material P to pass, as illustrated in FIG. 3B, because the moisture contained in the sheet material P becomes water vapor. The width W2 is exemplified here as 300 mm. The second intake portion 104b exhausts air without intervention of the filter. The length of the flow path of the air to be exhausted in the second intake portion 104b is larger than the length of the flow path of the air to be exhausted in the first intake portion 104a.

The discharge roller 115 serving as a conveyance member is located downstream of the fixing portion 101 in the conveyance direction of the sheet material P (hereinafter, simply referred to as a “conveyance direction”). The discharge roller 115 forms the discharge nip portion T4 with a pair of rollers abutting on each other. The discharge roller 115 nips the sheet material P conveyed by the fixing portion 101 at the discharge nip portion T4 and conveys the sheet material P to the discharge roller 78.

The controller 500 controls the entire operation of the image forming apparatus 100.

The sheet material P discharged by the discharge roller 78 is placed on the in-body discharge portion 601.

The sheet feeding portion 800 stores the sheet material P and feeds the stored sheet material P to the registration roller 75 via the conveyance path 74. The sheet feeding portion 800 includes a sheet feeding cassette 72 and a sheet feeding roller 73.

The sheet feeding cassette 72 is disposed on the lower part of the image forming apparatus 100. The sheet material P is accommodated in the sheet feeding cassette 72.

The sheet feeding roller 73 feeds the sheet materials P stored in the sheet feeding cassette 72 one by one to the registration roller 75 via the conveyance path 74.

The image forming apparatus 100 having the above configuration stores an image input by an image input unit (not illustrated) such as a connected personal computer, and secondarily transfers toner images formed in the image forming portions PY, PM, PC, and PK using an electrophotographic process to the sheet material P.

In the image forming apparatus 100, the sheet feeding portion 800 is disposed in the down direction which is the gravity direction with respect to the discharge roller 78, and the sheet material P is conveyed upward with respect to the sheet feeding portion 800.

### <UFP Generation Mechanism>

A generation mechanism of UFPs in the image forming apparatus 100 according to the first embodiment of the present invention will be described in detail.

In the fixing portion 101, the high-temperature endless belt 107 is brought into contact with the sheet material P to fix a toner image. In this case, an offset phenomenon in which a part of the toner is transferred (attached) to the endless belt 107 may occur, and such an offset phenomenon causes an image defect. Therefore, a countermeasure against the offset phenomenon is essential.

As the countermeasure, toner containing wax serving as a release agent is used. In a case where the toner containing the wax is heated, the wax is melted and oozes out. As a result, the surface of the endless belt 107 of the fixing portion 101 is covered with the wax dissolved in the fixing process, so that the toner hardly adheres.

Here, the wax includes not only a pure wax but also a compound containing a molecular structure of the wax. The compound containing the molecular structure of the wax is, for example, a compound in which a resin molecule of the toner and a wax molecular structure such as a hydrocarbon chain react with each other. As the release agent, in addition to the wax, a substance having a release action such as silicon oil may be used.

In a case where the wax is melted, a part thereof is vaporized (volatilized). This is considered to be because the size of the molecular component contained in the wax varies. That is, the wax contains a low molecular component having a short chain and a low boiling point and a high molecular component having a long chain and a high boiling point, and it is considered that the low molecular component having a low boiling point is vaporized first. In a case where the vaporized (gasified) wax component is cooled in the air, UFPs which are fine particles of about several nm to several hundred nm are generated (most of the generated fine particles are assumed to have a particle diameter of several nm to several tens nm).

The UFPs are generated the most from the fixing nip portion T3 that applies heat to the wax. The temperature of the endless belt 107 becomes the highest on the upstream side of the fixing nip portion T3 in the conveyance direction from the rotation direction of the endless belt 107, the disposition of the heater 109, and the like. Therefore, the generation of the UFPs is also maximized on the upstream side of the fixing nip portion T3 in the conveyance direction. Since the UFPs are generated from the toner image transferred to the sheet material P, the UFPs are generated from the entire region of the image forming region of the fixing nip portion T3.

### <Water Vapor Generation Mechanism>

A water vapor generation mechanism in the image forming apparatus 100 according to the first embodiment of the present invention will be described in detail.

The sheet material P is heated and pressed at the fixing nip portion T3 of the fixing portion 101. In this case, moisture contained in the sheet material P is generated as water vapor from the sheet material P. Since the water vapor generated from the sheet material P is generated immediately after the sheet material P is heated in the fixing portion 101, the water vapor is mainly generated on the downstream side of the fixing nip portion T3 in the conveyance direction.

### <Operation Using Exhaust Duct of Image Forming Apparatus>

An operation using the exhaust duct 114 of the image forming apparatus 100 according to the first embodiment of the present invention will be described in detail with reference to FIGS. 2 and 3.

In a case where the toner image secondarily transferred to the sheet material P is heated at the fixing nip portion T3 of the fixing portion 101, UFPs are generated from the toner of the toner image. The UFPs thus generated are taken in from the intake port 104c of the first intake portion 104a by a flow generated by the fan 103 of the exhaust duct 114 and are directed toward the exhaust port 111.

The UFPs directed toward the exhaust port 111 are collected by the filter 102. As a result, it is possible to reliably collect the UFPs in a situation in which the sheet material P is heated by the endless belt 107 of which the surface has a high temperature and the UFPs are likely to be generated.

In a case where the sheet material P is heated at the fixing nip portion T3 of the fixing portion 101, moisture contained in the sheet material P evaporates to generate water vapor. The water vapor generated as described above is mainly taken in from the intake port 104d of the second intake portion 104b and directed toward the exhaust port 111 by the flow generated by the fan 103, and is also taken in from the intake port 104c of the first intake portion 104a and directed toward the exhaust port 111.

The water vapor directed toward the exhaust port 111 is discharged to the outside of the image forming apparatus 100 via the exhaust port 111 and the louver 105.

The present embodiment provides the exhaust duct 114 including the first intake portion 104a and the second intake portion 104b. The first intake portion 104a includes the intake port 104c that is located between the transfer nip portion T2 and the fixing nip portion T3 and takes in air, and the filter 102. The second intake portion 104b includes the intake port 104d that is located between the fixing nip portion T3 and the discharge roller 115 and takes in air. As a result, it is possible to collect UFPs and appropriately discharge water vapor to the outside of the image forming apparatus 100 without increasing the size of the apparatus.

Although the filter 102 is provided on the intake port 104c side of the first intake portion 104a in the present embodiment, the present invention is not limited thereto, and the filter 102 may be provided at any position of the first intake portion 104a.

In the present embodiment, the door 112 is provided on the apparatus side surface 100a on the right side of the image forming apparatus 100 in FIG. 1, but the present invention is not limited thereto, and the door 112 may be provided on the apparatus side surface on the left side of the image forming apparatus 100 in FIG. 1. In this case, the exhaust duct 114 is provided on the left side of the image forming apparatus 100 in FIG. 1.

In the present embodiment, the first intake portion 104a is linear in the left-right direction, but the present invention is not limited thereto, and the first intake portion 104a may be curved.

In the present embodiment, the second intake portion 104b is linear in the left-right direction and the up-down direction, but the present invention is not limited thereto, and the second intake portion 104b may be curved.

### Second Embodiment

Since a configuration of an image forming apparatus according to the second embodiment of the present invention is the same as that in FIG. 1, the description thereof will be omitted.

### <Configuration of Image Forming Apparatus>

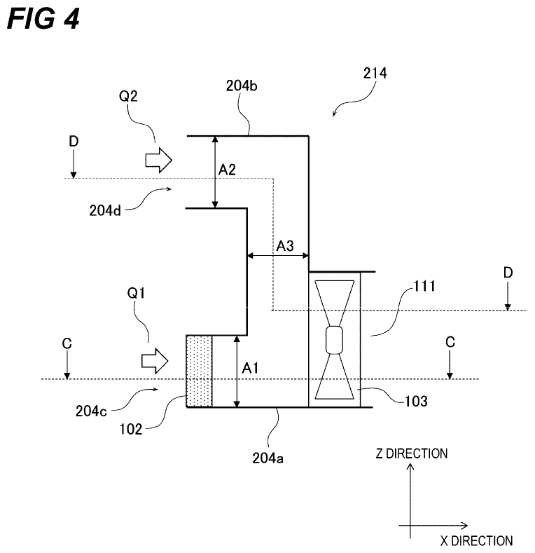

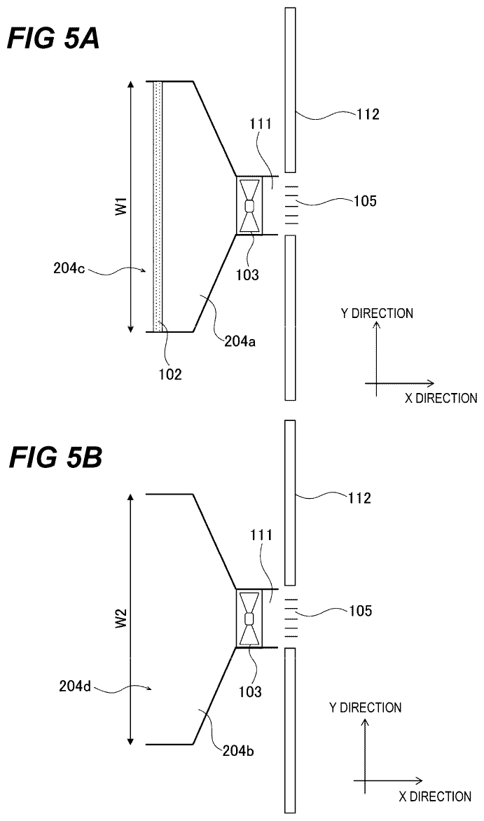

A configuration of an image forming apparatus according to a second embodiment of the present invention will be described in detail with reference to FIGS. 4 to 5B.

In FIGS. 5A and 5B, FIG. 5A is a cross-sectional view taken along line C-C in FIG. 4, and FIG. 5B is a cross-sectional view taken along line D-D in FIG. 4.

In FIGS. 4 to 5B, portions having the same configurations as those in FIGS. 1 to 3B are denoted by the same reference numerals, and the description thereof will be omitted.

The image forming apparatus of the present embodiment includes an intermediate transfer belt 8, a tension roller 10, a transfer cleaner device 11, a registration roller 75, a secondary transfer inner roller 76, a secondary transfer outer roller 77, and a discharge roller 78. The image forming apparatus of the present embodiment includes a fixing portion 101, a filter 102, a fan 103, a louver 105, an exhaust port 111, a door 112, a discharge roller 115, a transfer portion 120, an exhaust duct 214, a controller 500, an in-body discharge portion 601, and a sheet feeding portion 800.

The filter 102 is provided on the exhaust port 111 side of the first intake portion 204a. As illustrated in FIG. 5A, the filter 102 extends in the front-rear direction which is the longitudinal direction of the secondary transfer outer roller 77. The filter 102 is provided on an intake port 204c side (that will be described later) of a first intake portion 204a, and collects (filters) UFPs from the air taken in from an intake port 204c.

The fan 103 forcibly discharges the air around the fixing nip portion T3 to the outside of the image forming apparatus 100 by generating a flow from the intake port 204c of the first intake portion 204a and an intake port 204d of a second intake portion 204b toward the exhaust port 111.

The exhaust port 111 is provided between the fan 103 and the louver 105, and allows the first intake portion 204a and the second intake portion 204b to communicate with the outside of the image forming apparatus 100 via the louver 105.

The exhaust duct 214 is provided between the fixing portion 101 and the door 112. The exhaust duct 214 collects UFPs and discharges water vapor to the outside of the image forming apparatus. The exhaust duct 214 includes the first intake portion 204a and the second intake portion 204b.

The first intake portion 204a serving as a first exhaust path portion is provided on the opposite side to the exhaust port 111 with respect to the fan 103. The first intake portion 204a includes the intake port 204c at the end on the opposite side to the exhaust port 111 side. The intake port 204c is located between the fixing nip portion T3 and the transfer nip portion T2 in the up-down direction and takes in air. The first intake portion 204a is provided to collect, by the filter 102, a UFP which is a substance generated inside the image forming apparatus 100 mainly by heating toner containing a release agent. The first intake portion 204a exhausts air via the filter 102.

The second intake portion 204b serving as a second exhaust path portion is provided on the opposite side to the exhaust port 111 with respect to the fan 103. The second intake portion 204b includes the intake port 204d at the end on the opposite side to the exhaust port 111 side. The intake port 204d is located between the fixing nip portion T3 and the discharge nip portion T4 of the discharge roller 115 in the up-down direction and takes in air. The second intake portion 204b is provided to discharge water vapor generated inside the image forming apparatus 100 to the outside of the image forming apparatus 100. The width W2 of the second intake portion 204b in the longitudinal direction is preferably the width of the maximum size that allows the sheet material P to pass, as illustrated in FIG. 5B, because the moisture contained in the sheet material P becomes water vapor. The second intake portion 204b exhausts air without intervention of the filter. The length of the flow path of the air to be exhausted in the second intake portion 204b is larger than the length of the flow path of the air to be exhausted in the first intake portion 204a.

An opening height A2 of the second intake portion 204b is smaller than an opening height A1 of the first intake portion 204a (A1>A2). The opening height A1 of the first intake portion 204a is exemplified here as 30 mm. The opening height A2 of the second intake portion 204b is exemplified here as 10 mm. A width A3 of the second intake portion 204b on the fan 103 side is exemplified here as 40 mm.

### <Operation Using Exhaust Duct of Image Forming Apparatus>

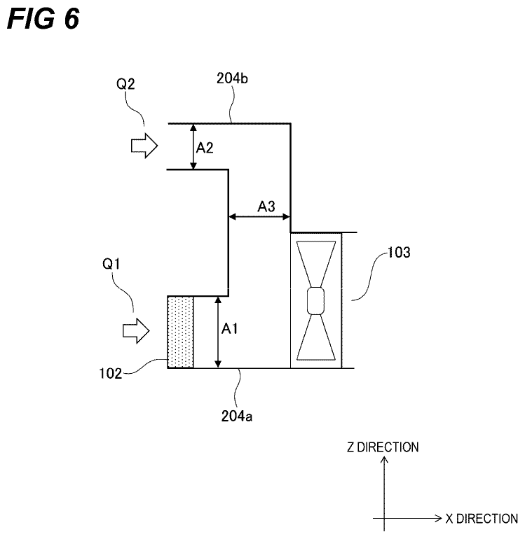

An operation using the exhaust duct 214 of the image forming apparatus according to the second embodiment of the present invention will be described in detail with reference to FIGS. 4 to 7B.

In general, the pressure loss of the filter 102 is larger than the pressure loss of the exhaust duct 214. Therefore, an amount of intake air taken in by the second intake portion 204b not provided with the filter 102 is larger than an amount of intake air taken in by the first intake portion 204a provided with the filter 102. Therefore, an intake air volume Q1 taken in by the first intake portion 204a is smaller than an intake air volume Q2 taken in by the second intake portion 204b (Q1<Q2).

For example, in a case where the opening height A1 is 30 mm, the width W1 is 300 mm, the opening height A2 is 30 mm, and the width W2 is 300 mm, the intake air volume Q1 is 0.001 m\hat{ }3/min and the intake air volume Q2 is 0.69 m\hat{ }3/min. In this case, the intake air volume Q1 is smaller than the intake air volume Q2.

There are two means for increasing the intake air volume Q1. First means is to use an electrostatic nonwoven fabric having a small thickness or fiber density as the filter 102 to reduce the pressure loss of the first intake portion 204a. However, in a case where an electrostatic nonwoven fabric having a small thickness or fiber density is used as the filter, the UFP collecting performance deteriorates.

Second means is to increase a ratio of the intake amount of the first intake portion 204a to the intake amount of the second intake portion 204b by increasing the pressure loss of the second intake portion 204b. In a case where the pressure loss of the second intake portion 204b is increased, air intake from the second intake portion 204b becomes difficult, and air intake from the first intake portion 204a becomes easy.

In general, a pressure loss P of the duct is obtained from the following Equation (1).

P=ξ·γ·(V\hat{ }2)/2=ξ·γ·((Q/60A)\hat{ }2)/2 (1)
where ξ is a duct-specific loss factor
γ is a density of the gas
V is a wind speed (m/s)
Q is an intake air volume (m\hat{ }3/min), and
A is a cross-sectional area of the duct (m\hat{ }2).

As can be seen from Equation (1), the pressure loss of the duct increases as the cross-sectional area of the duct decreases.

In the present embodiment, in a case where the opening height A1 and the opening height A2 have the same magnitude, the intake air volume Q2 of the second intake portion 204b becomes sufficiently large because the filter 102 is not disposed. On the other hand, in a case where the opening height A1 and the opening height A2 have the same magnitude, the first intake portion 204a is provided with the filter 102, so that the intake air volume Q1 becomes an air volume corresponding to about a faint wind. The generation amount of UFPs varies depending on a configuration of the fixing portion 101 and a toner material. Thus, in a case where the generation amount of UFPs increases, it is necessary to increase the intake air volume Q1 in order to enhance the UFP collecting performance.

Therefore, in the present embodiment, in order to increase the pressure loss of the second intake portion 204b, the opening height A2 of the second intake portion 204b is made smaller than the opening height A1 of the first intake portion 204a (A1>A2).

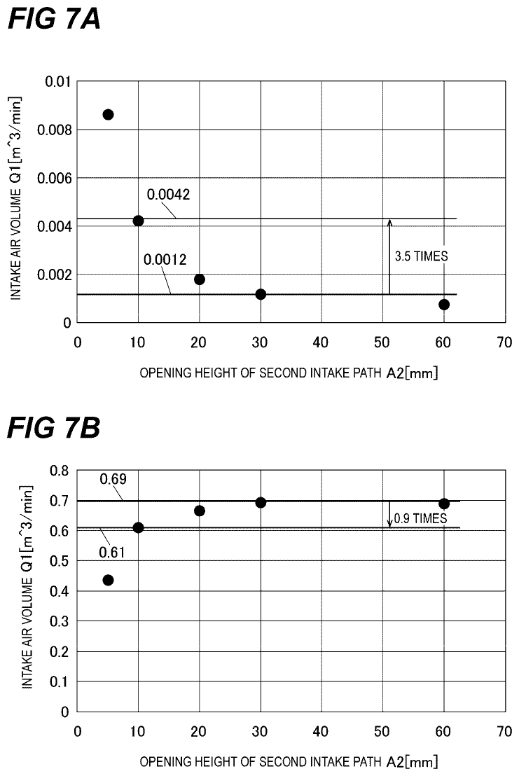

FIG. 7A illustrates a change in the intake air volume Q1 in a case where the opening height of the second intake portion 204b is changed. FIG. 7B illustrates a change in the intake air volume Q2 at this time. FIGS. 7A and 7B illustrate changes in the intake air volume Q1 and the intake air volume Q2 in a case where the opening height A2 is 30 mm which is the same as the opening height A1, and in a case where the opening height A2 is 30 mm and the opening height A2 is 10 mm which is smaller than the opening height A1.

As can be seen from FIG. 7A, the intake air volume Q1 in a case where the opening height A2 is 10 mm is 3.5 times larger than the intake air volume Q1 in a case where the opening height A2 is 30 mm. Therefore, it can be seen that the UFP collecting performance is enhanced in a case where the opening height A2 is 10 mm compared with a case where the opening height A2 is 30 mm.

On the other hand, as illustrated in FIG. 7B, the intake air volume Q2 in a case where the opening height A2 is 10 mm tends to decrease by 0.9 times compared with the intake air volume Q2 in a case where the opening height A2 is 30 mm. However, since the filter 102 is not disposed in the second intake portion 204b, the intake air volume Q2 is large in the first place, so that water vapor can be sufficiently discharged.

Since an operation of the exhaust duct 214 other than the above is the same as the operation of the exhaust duct 114, the description thereof will be omitted.

According to the present embodiment, by making the opening height A2 of the second intake portion 204b smaller than the opening height A1 of the first intake portion 204a, in addition to the effect of the above-described first embodiment, a decrease in the intake air volume Q1 can be curbed.

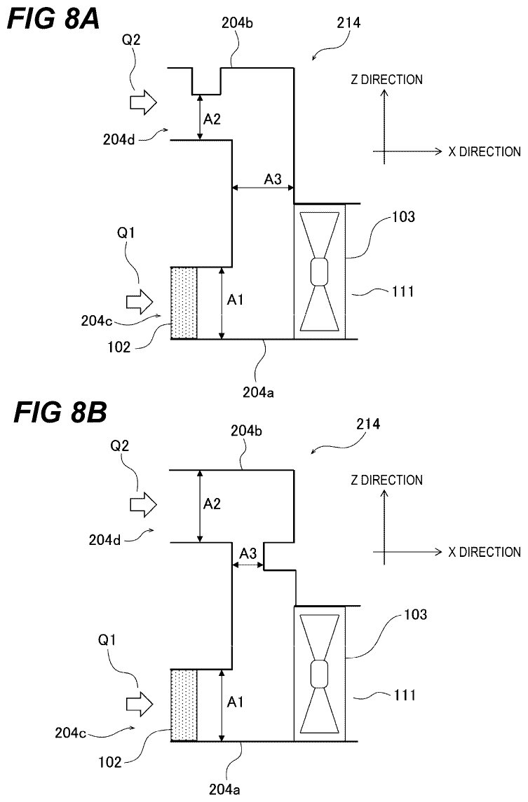

In the present embodiment, the entire opening height A2 of the second intake portion 204b is made small, but the present invention is not limited thereto, and the opening height A2 of a part of the second intake portion 204b may be made small. Specifically, as illustrated in FIG. 8A, a similar effect can be obtained by making the opening height A2 of a part of the second intake portion 204b small.

In the present embodiment, the opening height A2 is smaller than the opening height A1, but the present invention is not limited thereto. As long as the cross-sectional area of the second intake portion 204b can be made smaller than the cross-sectional area of the first intake portion 204a, a height other than the opening height may be changed. For example, as illustrated in FIG. 8B, a similar effect can be obtained by reducing the width A3 of the second intake portion 204b instead of the opening height A2 of the second intake portion 204b.

In the present embodiment, the door 112 is provided on the apparatus side surface 100a on the right side of the image forming apparatus 100 in FIG. 1, but the present invention is not limited thereto, and the door 112 may be provided on the apparatus side surface on the left side of the image forming apparatus 100 in FIG. 1. In this case, the exhaust duct 214 is provided on the left side of the image forming apparatus 100 in FIG. 1.

In the present embodiment, the first intake portion 204a is linear in the left-right direction, but the present invention is not limited thereto, and the first intake portion 204a may be curved.

In the present embodiment, the second intake portion 204b is linear in the left-right direction and the up-down direction, but the present invention is not limited thereto, and the second intake portion 204b may be curved.

### Third Embodiment

### <Configuration of Image Forming Apparatus>

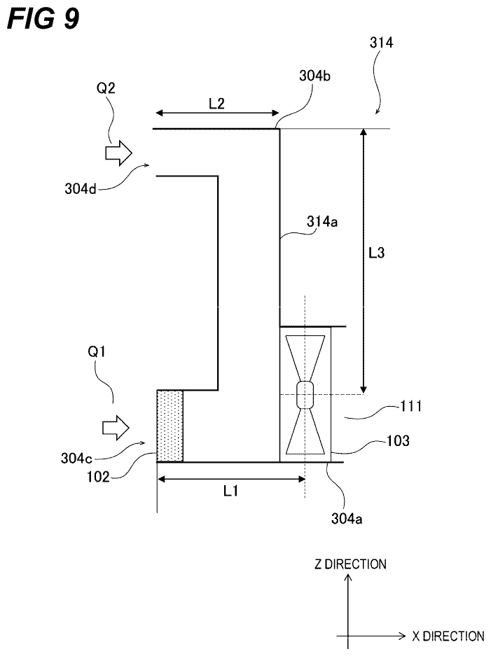

A configuration of an image forming apparatus according to a third embodiment of the present invention will be described in detail with reference to FIG. 9.

In FIG. 9, the same constituents as those in FIGS. 1 to 3B are denoted by the same reference numerals, and the description thereof will be omitted.

The image forming apparatus of the present embodiment includes an intermediate transfer belt 8, a tension roller 10, a transfer cleaner device 11, a registration roller 75, a secondary transfer inner roller 76, a secondary transfer outer roller 77, and a discharge roller 78. The image forming apparatus of the present embodiment includes a fixing portion 101, a filter 102, a fan 103, a louver 105, an exhaust port 111, a door 112, a discharge roller 115, a transfer portion 120, an exhaust duct 314, a controller 500, an in-body discharge portion 601, and a sheet feeding portion 800.

The filter 102 is provided on an intake port 304c side (that will be described later) of a first intake portion 304a, and collects (filters) UFPs from air taken in from the intake port 304c.

The fan 103 forcibly discharges the air around the fixing nip portion T3 to the outside of the image forming apparatus 100 by generating a flow from the intake port 304c of the first intake portion 304a and an intake port 304d of a second intake portion 304b toward the exhaust port 111.

The exhaust port 111 is provided between the fan 103 and the louver 105, and allows the first intake portion 304a and the second intake portion 304b to communicate with the outside of the image forming apparatus 100 via the louver 105.

The exhaust duct 314 is provided between the fixing portion 101 and the door 112. The exhaust duct 314 collects UFPs and discharges water vapor to the outside of the image forming apparatus. The exhaust duct 314 includes the first intake portion 304a and the second intake portion 304b.

The first intake portion 304a serving as a first exhaust path portion is provided on the opposite side to the exhaust port 111 with respect to the fan 103. The first intake portion 304a includes the intake port 304c at the end on the opposite side to the exhaust port 111 side. The intake port 304c is located between the fixing nip portion T3 and the transfer nip portion T2 in the up-down direction and takes in air. The first intake portion 304a is provided to collect, by the filter 102, a UFP which is a substance generated inside the image forming apparatus 100 mainly by heating toner containing a release agent. The first intake portion 304a exhausts air via the filter 102.

The second intake portion 304b as the second exhaust path portion is provided on the opposite side to the exhaust port 111 with respect to the fan 103. The second intake portion 304b includes the intake port 304d at the end on the opposite side to the exhaust port 111 side. The intake port 304d is located between the fixing nip portion T3 and the discharge nip portion T4 of the discharge roller 115 in the up-down direction and takes in air. The second intake portion 304b is provided to discharge water vapor generated inside the image forming apparatus 100 to the outside of the image forming apparatus 100. The width W2 of the second intake portion 304b in the longitudinal direction is preferably the width of the maximum size that allows the sheet material P to pass since the moisture contained in the sheet material P becomes water vapor. The second intake portion 304b exhausts air without intervention of the filter. The length of the flow path of the air to be exhausted in the second intake portion 304b is larger than the length of the flow path of the air to be exhausted in the first intake portion 304a.

An exhaust path length (L2+L3) of the second intake portion 304b is set to be larger than an exhaust path length L1 of the first intake portion 304a (L1<(L2+L3)). Here, L1 is a distance in the left-right direction from the intake port 304c of the first intake portion 304a to the center of the fan 103. L2 is a distance in the left-right direction from the intake port 304d of the second intake portion 304b to a wall portion 314a of the exhaust duct 314 extending in the up-down direction. L3 is a distance in the up-down direction from the upper end of the wall portion 314a of the exhaust duct 314 to the center of the fan 103. The exhaust path length L1 is the length of the flow path of air taken in by the first intake portion 304a. The exhaust path length (L2+L3) is the length of the flow path of air taken in by the second intake portion 304b.

### <Operation Using Exhaust Duct of Image Forming Apparatus>

An operation using the exhaust duct 314 of the image forming apparatus according to the third embodiment of the present invention will be described in detail with reference to FIG. 9.

In a case where the length of the exhaust duct 314 is denoted by L and the width of the exhaust duct 314 is denoted by D, the duct-specific loss coefficient & in Equation (1) is proportional to L/D. That is, the pressure loss of the exhaust duct 314 increases as the length of the exhaust duct 314 increases.

In the present embodiment, setting the exhaust path length (L2+L3) of the second intake portion 304b to be larger than the exhaust path length L1 of the first intake portion 304a can increase the pressure loss of the second intake portion 304b.

Since an operation of the exhaust duct 314 other than the above is the same as the operation of the exhaust duct 114, the description thereof will be omitted.

According to the present embodiment, by making the exhaust path length (L2+L3) of the second intake portion 304b larger than the exhaust path length L1 of the first intake portion 304a, it is possible to curb a decrease in the intake air volume Q1 in addition to the effect of the above-described first embodiment.

In the present embodiment, the door 112 is provided on the apparatus side surface 100a on the right side of the image forming apparatus 100 in FIG. 1, but the present invention is not limited thereto, and the door 112 may be provided on the apparatus side surface on the left side of the image forming apparatus 100 in FIG. 1. In this case, the exhaust duct 314 is provided on the left side of the image forming apparatus 100 in FIG. 1.

In the present embodiment, the first intake portion 304a is linear in the left-right direction, but the present invention is not limited thereto, and the first intake portion 304a may be curved.

In the present embodiment, the second intake portion 304b is linear in the left-right direction and the up-down direction, but the present invention is not limited thereto, and the second intake portion 304b may be curved.

### Fourth Embodiment

### <Configuration of Image Forming Apparatus>

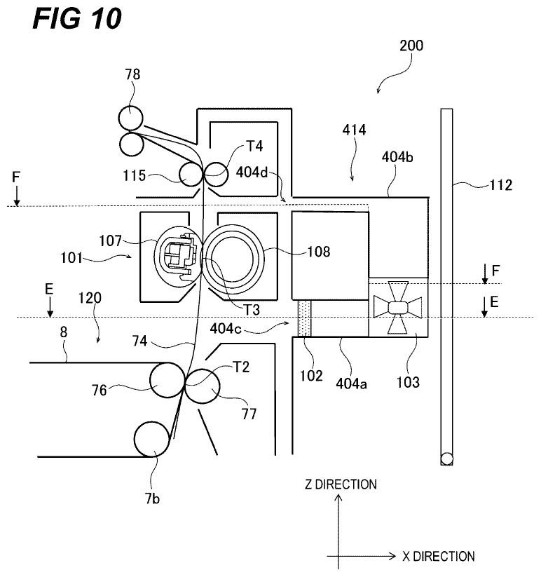

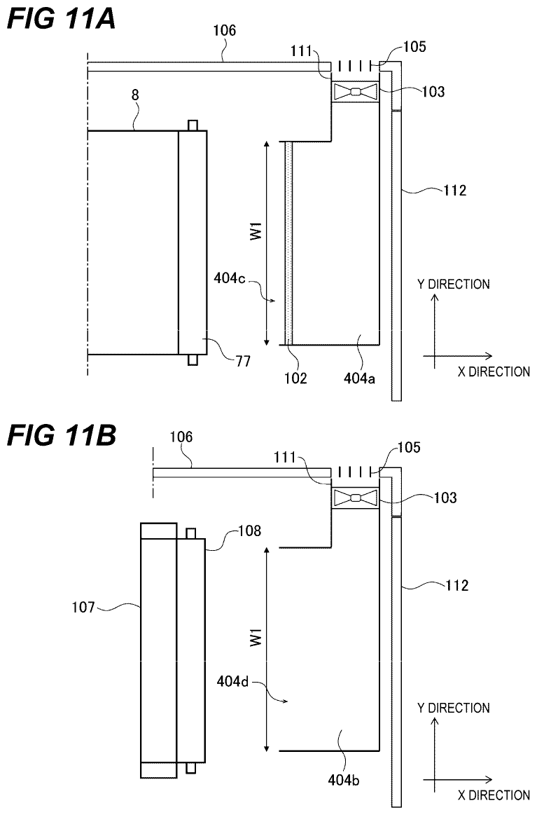

A configuration of an image forming apparatus 200 according to a fourth embodiment of the present invention will be described in detail with reference to FIGS. 10 to 11B.

In FIGS. 11A and 11B, FIG. 11A is a cross-sectional view taken along line E-E in FIG. 10, and FIG. 11B is a cross-sectional view taken along line F-F in FIG. 10.

Note that, in FIGS. 10 and 11, portions having the same configurations as those in FIGS. 1 to 3B are denoted by the same reference numerals, and description thereof will be omitted. In the configuration of the image forming apparatus 200, illustration and description of a portion having the same configuration as that of the image forming apparatus 100 will be omitted.

Here, the image forming apparatus 200 is exemplified by a laser type printer. The image forming apparatus 200 includes an image forming portion PY, an image forming portion PM, an image forming portion PC, an image forming portion PK, a laser scanner portion 3, an idler roller 7a, an idler roller 7b, an intermediate transfer belt 8, and a tension roller 10. The image forming apparatus 200 includes a transfer cleaner device 11, a registration roller 75, a secondary transfer inner roller 76, a secondary transfer outer roller 77, a discharge roller 78, and a fixing portion 101. The image forming apparatus 200 further includes a louver 105, a door 112, a discharge roller 115, a transfer portion 120, an exhaust duct 414, a controller 500, an in-body discharge portion 601, and a sheet feeding portion 800.

The louver 105 is provided on a back cover 106 configuring a back surface portion of the image forming apparatus 200, and allows the inside of the exhaust duct 414 to communicate with the outside. The louver 105 enables water vapor to be discharged from the exhaust duct 414 to the outside of the image forming apparatus 200.

The filter 102 is provided on an intake port 404c side (that will be described later) of a first intake portion 404a, and collects (filters) UFPs from air taken in from the intake port 404c. As illustrated in FIG. 11A, the filter 102 extends in the front-rear direction which is the longitudinal direction of the secondary transfer outer roller 77.

The fan 103 forcibly discharges the air around the fixing nip portion T3 to the outside of the image forming apparatus 200 by generating a flow from the intake port 404c of the first intake portion 404a and an intake port 404d of a second intake portion 404b toward the exhaust port 111.

The exhaust port 111 is provided between the fan 103 and the louver 105, and allows the first intake portion 404a and the second intake portion 404b to communicate with the outside of the image forming apparatus 200 via the louver 105.

The exhaust duct 414 is provided between the fixing portion 101 and the back cover 106 provided on the apparatus back surface of the image forming apparatus 200. The exhaust duct 414 collects UFPs and discharges water vapor to the outside of the image forming apparatus 200. The exhaust duct 414 includes the first intake portion 404a and the second intake portion 404b.

The first intake portion 404a is provided on the opposite side to the exhaust port 111 with respect to the fan 103. The first intake portion 404a includes the intake port 404c at the end on the opposite side to the exhaust port 111 side. The intake port 404c is located between the fixing nip portion T3 and the transfer nip portion T2 in the up-down direction and takes in air. The first intake portion 404a is provided to collect, by the filter 102, a UFP which is a substance generated inside the image forming apparatus 200 mainly by heating toner containing a release agent. The first intake portion 404a exhausts air via the filter 102.

The second intake portion 404b is provided on the opposite side to the exhaust port 111 with respect to the fan 103. The second intake portion 404b includes the intake port 404d at the end on the opposite side to the exhaust port 111 side. The intake port 404d is located between the fixing nip portion T3 and the discharge nip portion T4 of the discharge roller 115 in the up-down direction and takes in air. The second intake portion 404b is provided to discharge water vapor generated inside the image forming apparatus 200 to the outside of the image forming apparatus 200. The width W2 of the second intake portion 404b in the longitudinal direction is preferably the width of the maximum size that allows the sheet material P to pass since the moisture contained in the sheet material P becomes water vapor. The second intake portion 404b exhausts air without intervention of the filter. The length of the flow path of the air to be exhausted in the second intake portion 404b is larger than the length of the flow path of the air to be exhausted in the first intake portion 404a.

Since an operation using the exhaust duct 414 of the image forming apparatus 200 of the present embodiment is the same as the operation using the exhaust duct 114 of the image forming apparatus 100, the description thereof will be omitted.

In the present embodiment, the exhaust duct 414 is provided between the fixing portion 101 and the back cover 106 on the apparatus back surface of the image forming apparatus 200. As a result, in addition to the effect of the first embodiment described above, water vapor generated from the sheet material P can be discharged to the back surface side of the image forming apparatus 200.

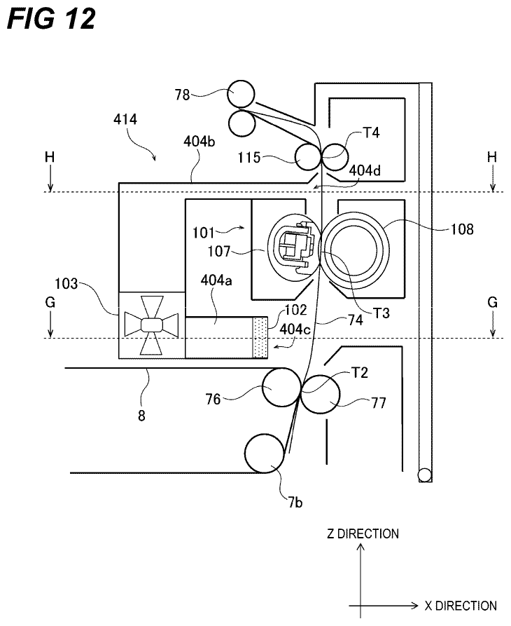

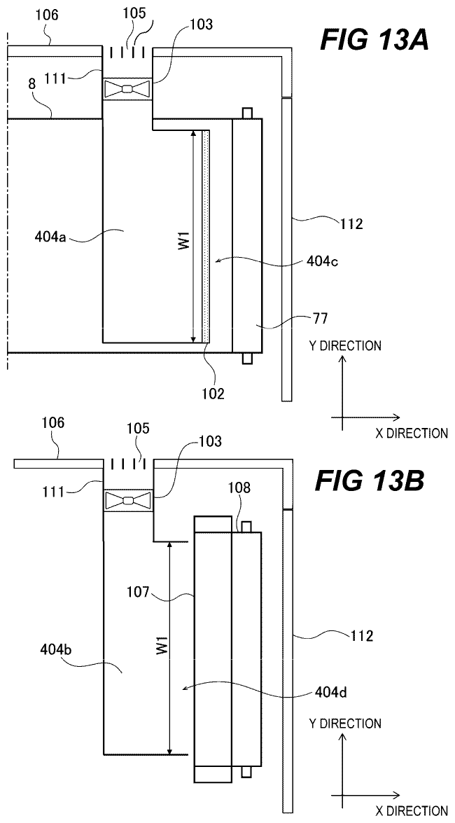

In the present embodiment, the first intake portion 404a and the second intake portion 404b are provided on the right side with respect to the conveyance path 74 in the left-right direction. However, the present invention is not limited thereto, and as illustrated in FIGS. 12 to 13B, the first intake portion 404a and the second intake portion 404b may be provided on the left side with respect to the conveyance path 74 in the left-right direction.

In the present embodiment, the first intake portion 404a is linear in the left-right direction and the front-rear direction, but the present invention is not limited thereto, and the first intake portion 404a may be curved.

In the present embodiment, the second intake portion 404b is formed linearly along the left-right direction, the up-down direction, and the front-rear direction, but the present invention is not limited thereto, and the second intake portion 404b may be formed in a curved shape.

### Fifth Embodiment

### <Configuration of Image Forming Apparatus>

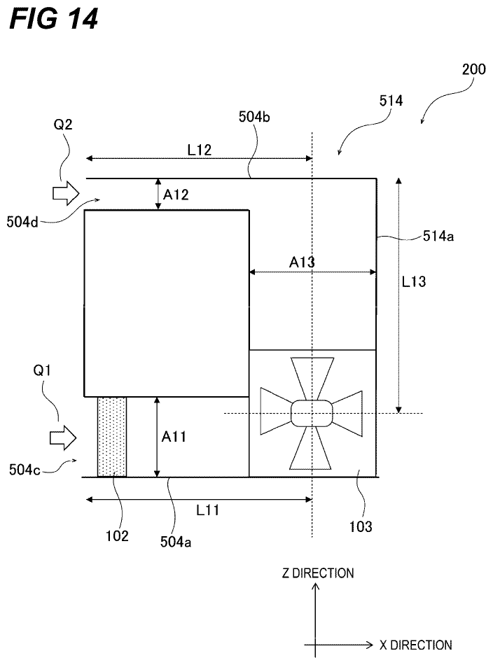

A configuration of an image forming apparatus according to a fifth embodiment of the present invention will be described in detail with reference to FIG. 14.

In a configuration of the image forming apparatus according to the present embodiment, portions having the same configuration as the configuration of the image forming apparatus 100 according to the above-described first embodiment are denoted by the same reference numerals, and illustration and description thereof will be omitted.

The image forming apparatus according to the present embodiment includes an image forming portion PY, an image forming portion PM, an image forming portion PC, an image forming portion PK, a laser scanner portion 3, an idler roller 7a, and an idler roller 7b. The image forming apparatus according to the present embodiment includes an intermediate transfer belt 8, a tension roller 10, a transfer cleaner device 11, a registration roller 75, a secondary transfer inner roller 76, a secondary transfer outer roller 77, a discharge roller 78, and a fixing portion 101. The image forming apparatus according to the present embodiment includes a filter 102, a fan 103, a louver 105, an exhaust port 111, a door 112, a discharge roller 115, a transfer portion 120, an exhaust duct 514, a controller 500, an in-body discharge portion 601, and a sheet feeding portion 800.

The louver 105 is provided on a back cover 106 configuring a back surface portion of the image forming apparatus, and allows the inside of the exhaust duct 514 to communicate with the outside. The louver 105 enables water vapor to be discharged from the exhaust duct 514 to the outside of the image forming apparatus.

The filter 102 is provided on an intake port 504c side (that will be described later) of a first intake portion 504a, and collects (filters) UFPs from air taken in from the intake port 504c.

The fan 103 forcibly discharges the air around the fixing nip portion T3 to the outside of the image forming apparatus by generating a flow from the intake port 504c of the first intake portion 504a and an intake port 504d of a second intake portion 504b toward the exhaust port 111.

The exhaust port 111 is provided between the fan 103 and the louver 105, and allows the first intake portion 504a and the second intake portion 504b to communicate with the outside of the image forming apparatus 100 via the louver 105.

The exhaust duct 514 is provided between the fixing portion 101 and the back cover 106 provided on the apparatus back surface of the image forming apparatus. The exhaust duct 514 collects UFPs and discharges water vapor to the outside of the image forming apparatus. The exhaust duct 514 includes the first intake portion 504a and the second intake portion 504b.

The first intake portion 504a is provided on the opposite side to the exhaust port 111 with respect to the fan 103. The first intake portion 504a includes the intake port 504c at the end on the opposite side to the exhaust port 111. The intake port 104c is located between the fixing nip portion T3 and the transfer nip portion T2 in the up-down direction and takes in air. The first intake portion 504a is provided to collect, by the filter 102, a UFP which is a substance generated inside the image forming apparatus 200 mainly by heating toner containing a release agent. The first intake portion 504a exhausts air via the filter 102.

The second intake portion 504b is provided on the opposite side to the exhaust port 111 with respect to the fan 103. The second intake portion 504b includes the intake port 504d at the end on the opposite side to the exhaust port 111 side. The intake port 504d is located between the fixing nip portion T3 and the discharge nip portion T4 of the discharge roller 115 in the up-down direction and takes in air. The second intake portion 504b is provided to discharge water vapor generated inside the image forming apparatus 200 to the outside of the image forming apparatus 200. The width W2 of the second intake portion 504b in the longitudinal direction is preferably the width of the maximum size that allows the sheet material P to pass since the moisture contained in the sheet material P becomes water vapor. The second intake portion 504b exhausts air without intervention of the filter. The length of the flow path of the air to be exhausted in the second intake portion 504b is larger than the length of the flow path of the air to be exhausted in the first intake portion 504a.

An opening height A12 of the second intake portion 504b is smaller than an opening height A11 of the first intake portion 504a (A11>A12). The opening height A11 of the first intake portion 504a is exemplified here as 30 mm. The opening height A12 of the second intake portion 504b is exemplified here as 10 mm. A width A13 of the second intake portion 504b on the fan 103 side is exemplified here as 40 mm.

An exhaust path length (L12+L13) of the second intake portion 504b is set to be larger than an exhaust path length L11 of the first intake portion 504a (L11<(L12+L13)). Here, L11 is a distance in the left-right direction from the intake port 504c of the first intake portion 504a to the center of the fan 103. L12 is a distance in the left-right direction from the intake port 504d of the second intake portion 504b to the center of the fan 103. L13 is a distance in the up-down direction from the upper end of an inner wall surface 514a of the exhaust duct 514 to the center of the fan 103. The exhaust path length L11 is the length of the flow path of air taken in by the first intake portion 504a. The exhaust path length (L12+L13) is the length of the flow path of air taken in by the second intake portion 504b.

An operation using the exhaust duct 514 of the image forming apparatus of the present embodiment is the same as the operation using the exhaust duct 214 of the image forming apparatus of the above-described second embodiment or the operation using the exhaust duct 314 of the image forming apparatus of the above-described third embodiment, and thus the description thereof will be omitted.

In the present embodiment, the exhaust duct 414 is provided between the fixing portion 101 and the back cover 106 on the apparatus back surface of the image forming apparatus. As a result, in addition to the effects of the first embodiment described above, water vapor generated from the sheet material P can be discharged to the back surface side of the image forming apparatus 200, and a decrease in the intake air volume Q1 can be curbed.

The present embodiment provides the configuration satisfying all of the condition that the opening height A11 is larger than the opening height A12, the condition that the opening height A11 is more than the width A13, and the condition that the intake path length L11 is larger than the intake path length (L12+L13). However, the present invention is not limited thereto, and there may be provided a configuration satisfying any one or two of the above conditions.

In the present embodiment, the opening height A12 of the entire second intake portion 504b is made small, but the present invention is not limited thereto, and an opening height of a part of the second intake portion 504b may be made small.

In the present embodiment, the opening height A12 is smaller than the opening height A11, but the present invention is not limited thereto. As long as the cross-sectional area of the second intake portion 504b can be made smaller than the cross-sectional area of the first intake portion 504a, any parameter other than the opening height may be changed. For example, a similar effect can be obtained by reducing the width A13 of the second intake portion 504b instead of the opening height A12 of the second intake portion 504b.

In the present embodiment, the first intake portion 504a and the second intake portion 504b are provided on the right side with respect to the conveyance path 74 in the left-right direction, but the present invention is not limited thereto, and the first intake portion 504a and the second intake portion 504b may be provided on the left side with respect to the conveyance path 74 in the left-right direction.

In the present embodiment, the first intake portion 504a is linear in the left-right direction and the front-rear direction, but the present invention is not limited thereto, and the first intake portion 504a may be curved.

In the present embodiment, the second intake portion 504b is linear in the left-right direction, the up-down direction, and the front-rear direction, but the present invention is not limited thereto, and the second intake portion 504b may be curved.

It goes without saying that the present invention is not limited to the first to fifth embodiments described above, and various modifications can be made without departing from the concept of the present invention.

Specifically, in the first to fifth embodiments, the filter 102 is a nonwoven fabric filter, but the present invention is not limited thereto, and the filter 102 may be a filter other than a nonwoven fabric filter, such as a honeycomb filter.

In the first to fifth embodiments, the width W1 is equal to or larger than the width of the maximum size of the sheet material P, but the present invention is not limited thereto, and the width W1 may be less than the width of the maximum size of the sheet material P.

In the first to fifth embodiments, the width W2 is equal to or larger than the width of the maximum size of the sheet material P, but the present invention is not limited thereto, and the width W2 may be less than the width of the maximum size of the sheet material P.

In the first to fifth embodiments, the sheet material P is heated by the endless belt 107, but the present invention is not limited thereto, and the sheet material P may be heated by a heating roller or a belt unit in which a belt is stretched around a plurality of rollers.

In the first to fifth embodiments, the image forming apparatus is a laser type printer, but the present invention is not limited thereto, and the image forming apparatus may be a printer other than a laser type, such as an inkjet type printer. Here, the inkjet type does not include a fixing device that applies heat and pressure to the sheet material P, but includes a drying unit, and thus has problems common to the problems of heat exhaust and air exhaust of the laser type printer.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-157349, filed Sep. 11, 2024, which is hereby incorporated by reference herein in its entirety.

What is claimed is:

1. An image forming apparatus that forms an image on a sheet material, the image forming apparatus comprising:
an image forming portion configured to form a toner image by using toner;
a transfer portion that includes a transfer nip portion configured to transfer the toner image formed by the image forming portion to the sheet material;
a fixing portion that includes a fixing nip portion configured to heat the sheet material to which the toner image has been transferred in the transfer nip portion and fix the toner image to the sheet material;
a conveyance member located downstream of the fixing portion in a conveyance direction of the sheet material and configured to convey the sheet material to which the toner image has been fixed in the fixing nip portion;
an exhaust duct provided with a filter and configured to take in air inside the image forming apparatus and exhaust the air to outside of the image forming apparatus; and
a fan connected to an exhaust port of the exhaust duct, wherein
the exhaust duct includes
a first exhaust path portion located between the transfer nip portion and the fixing nip portion and configured to exhaust air via the filter, and
a second exhaust path portion located between the fixing nip portion and the conveyance member and configured to exhaust air without intervention of the filter.

2. The image forming apparatus according to claim 1, wherein
a cross-sectional area of the second exhaust path portion is smaller than a cross-sectional area of the first exhaust path portion.

3. The image forming apparatus according to claim 1, wherein
a length of a flow path of air to be exhausted in the second exhaust path portion is larger than a length of a flow path of air to be exhausted in the first exhaust path portion.

4. The image forming apparatus according to claim 1, wherein
the filter collects a substance generated by heating a release agent contained in the toner.

5. The image forming apparatus according to claim 1, wherein
the filter is provided to extend in a width direction orthogonal to the conveyance direction of the sheet material.

6. The image forming apparatus according to claim 1, wherein
the exhaust duct is provided between the fixing portion and an apparatus side surface of the image forming apparatus.

7. The image forming apparatus according to claim 1, wherein
the exhaust duct is provided between the fixing portion and an apparatus back surface of the image forming apparatus.
